(19) United States
(12) Patent Application Publication
(10) Pub. No.: US 2019/0334930 A1
(43) Pub. Date: Oct. 31, 2019

(54) MOBILE DEVICE AND METHOD FOR ISOLATING AND PROTECTING A COMPUTER, NETWORKS, AND DEVICES FROM VIRUSES AND CYBER ATTACKS

(71) Applicant: Brian Abbe, Cicero, NY (US)

(72) Inventor: Brian Abbe, Cicero, NY (US)

(21) Appl. No.: 16/395,562

(22) Filed: Apr. 26, 2019

Related U.S. Application Data
(60) Provisional application No. 62/662,838, filed on Apr. 26, 2018.

(51) Int. Cl. H04L 29/06; G06F 9/455

(52) U.S. Cl. CPC H04L 63/1408; H04L 63/1466; G06F 2009/45595; G06F 2009/45587; G06F 9/45558

(57) ABSTRACT

A cyber-security method embodying a mobile computing device for isolating and thus protecting a coupled host computing device from internet-borne viruses and hacking. The mobile computing device provides an internet interface that locally and physically couples to the host computing device so that the mobile computing device can receive host requests for global internet access, wherein the mobile computing device is adapted to monitor and process data received from the global internet interface associated with the host requests and send benign code representations thereof through the local internet interface to the host computing device.

### CROSS-REFERENCE TO RELATED APPLICATION

This application claims the benefit of priority of U.S. provisional application No. 62/662,838, filed 26 Apr. 2018, the contents of which are herein incorporated by reference.

### BACKGROUND OF THE INVENTION

The present invention relates to cyber security and, more particularly, a cyber-security method embodying a mobile device for isolating and thus protecting a coupled computing device from Internet-borne viruses and cyber attacks.

Accessing the internet whether for work or for personal use opens up the user's computer and connected devices to web-borne viruses and cyber attacks. Users are unaware of these cyber-attacks and often are unsecured from preventing them, even when (and possibly because of a false sense of security enabled by) employing the current safeguards: anti-virus programs and/or whitelisting websites.

Anti-virus programs use a database of known virus digital “fingerprints”. If a new virus is not in the database it can slip through undetected. As a result, antivirus programs require users to update their software regularly to ensure they have the latest database. Often users do not have an up to date program, and so new viruses, called zero-day attacks, will penetrate and infect their computer and devices.

Whitelisting websites is often employed to allow users to access sites that are generally considered safe such as corporate pages, websites hosted on intranet servers, and popular social media websites. This is a dangerous practice because every website is vulnerable to hacking and thus the false sense of security can open users to malware hidden in these whitelisted pages. On the opposite side of the spectrum, some IT professionals will blacklist certain sites as an over the top method to prevent the possibility of being infected. This method, though effective, provides a diminished user experience because so many sites are candidates for blocking.

As can be seen, there is a need for a cyber security method embodying a mobile device for isolating and thus protecting coupled computing devices from Internet-borne viruses and hacking.

The mobile device is a small portable device adapted to attach to a computing platform through a physical interface port of any type and/or wirelessly using any protocol. Once activated, the device isolates the host computing platform from the Internet by intercepting global Internet traffic, performing any routine to sanitize the data, and then passes the sanitized data or representation of that data to the host computing platform for display and user interaction.

The mobile hardware device's ability to isolate the host computing platform from the Internet eliminates the need for a database of known viruses. It also prevents an infected file, email, or webpage, from ever reaching the host computing platform before it is sanitized and safe; in contrast, the current antivirus programs run on files that have already entered the host computer. The mobile hardware device solution is connected locally and therefore does not require the user to configure an antivirus program or incorporate a database of whitelisted and blacklisted websites. The local connection to the computing device/network provides a fast and seamless user experience.

The mobile hardware device is different from other virus/hacking prevention schemes because it does not use a known virus database approach. Instead, it completely isolates the user's computing platform from the Internet, through isolating virus and malicious content execution from the user's computing device. Further, it is better than cloud based and remote rendering server solutions because it does not exist on a system that is constantly exposed to Internet traffic and, thus, exposed to potential attacks. It is on only when the user employs it. It also protects the user from “man in the middle” attacks when accessing the Internet in public spaces such as coffee shops and airports.

### SUMMARY OF THE INVENTION

In one aspect of the present invention, method of providing cyber security for a host computing device includes the following: providing a mobile computing device providing a local internet interface adapted to isolate the host computing device, wherein the host computing device locally operatively associates with the internet interface, and wherein the internet interface is adapted to transfer electrical data and host requests; loading a web browser application on the mobile computing device, wherein the software application is adapted to handle said host requests for global internet access; retrieving the host requests via the web browser application, wherein the mobile computing device is adapted to process active code associated with the host requests; and sending benign code associated with said host request via the web browser application through the local internet interface to the host computing device.

In another aspect of the present invention, the method of providing cyber security for a host computing device including the following: providing a mobile computing device providing a local internet interface adapted to isolate the host computing device, wherein the host computing device locally and physically operatively associates with the internet interface, and wherein the internet interface is adapted to transfer electrical data and host requests; loading a web browser application on the mobile computing device, wherein the software application is adapted to handle said host requests for global internet access, wherein the web browser application includes a proxy server and a web rendering server, wherein the web browser application is adapted to implement a virtual network connection to the host computing device, and wherein the virtual network connection enables the host computing device to view and selectively control representations of the active code, wherein the web browser application includes switching functionality adapted to determine if said host requests for internet access includes a web browser request, an email request, or an data request, and wherein embedded links of the email request are treated as a web browser request, and wherein attached files of the email request are downloaded and scanned by the mobile computing device before sending the email request via the web browser application through the internet interface to the host computing device; retrieving the host requests via the web browser application, wherein the mobile computing device is adapted to process active code associated with the host requests; and sending benign code associated with said host request via the web browser application through the internet interface to the host computing device.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention; and

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cyber-security method embodying a mobile device for isolating and thus protecting a coupled computing device from Internet-borne viruses and hacking. The present invention improves the functioning of the host computing device as well as provides improvements in the computer-related technology of cyber security.

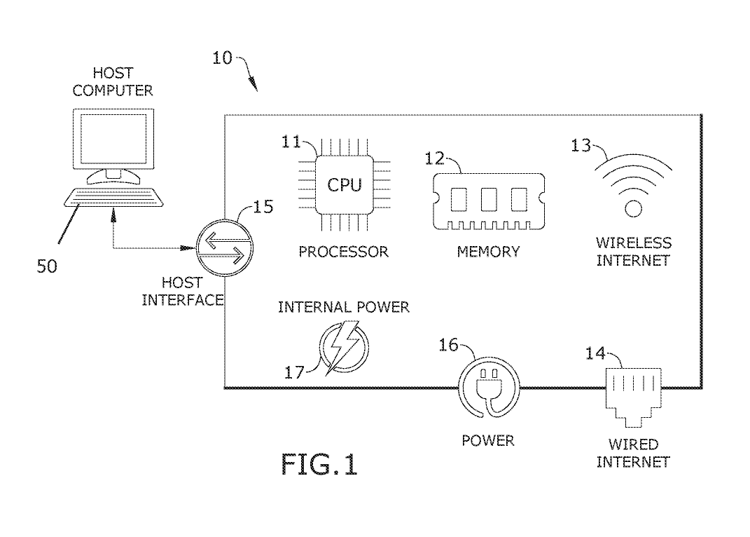

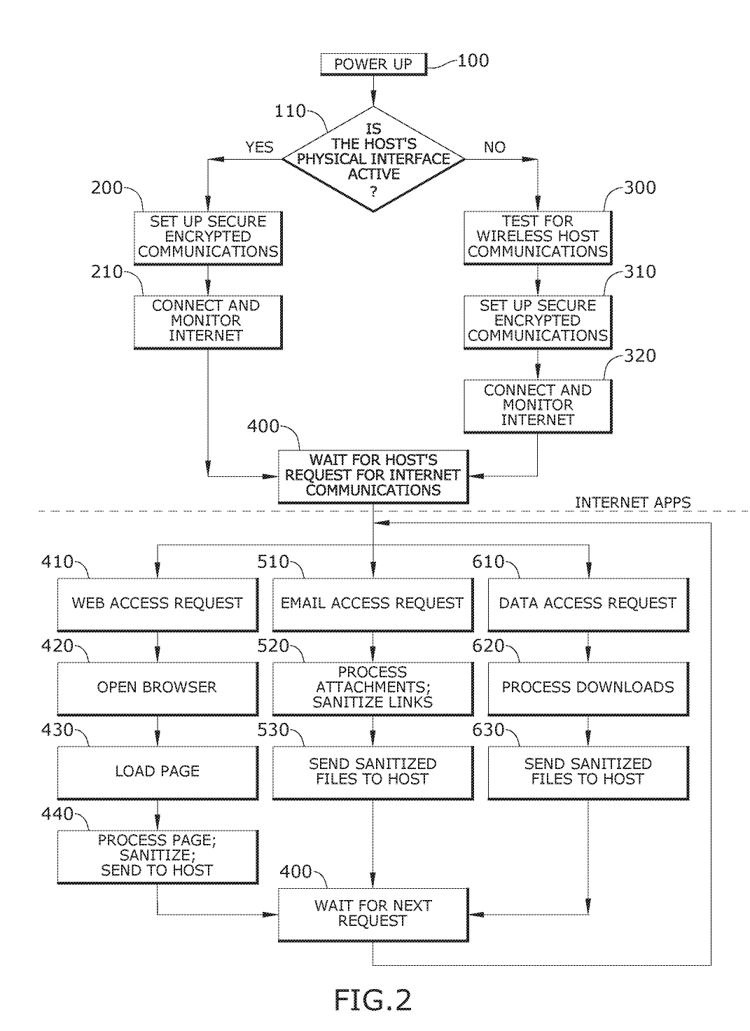

Referring now to FIGS. 1 and 2, the present invention may include at least one computing device 50 with a host user interface 15. The computing device 50 may include at least one processing unit and a form of memory including, but not limited to, a desktop, laptop, and smart device, such as, a tablet and smart phone. The computing device 50 includes a program product including a machine-readable program code for causing, when executed, the computing device 50 to perform steps. The program product may include a software application which may either be loaded onto each computing device 50 or accessed by each computing device 50. The loaded software application may include an application on a smart device. The software application may be accessed by the computing device 50 using a web browser. The computing device 50 may access the software via the web browser using the Internet, extranet, Intranet, host server, cloud-based computing environment, and the like.

Referring to FIG. 1, the mobile device 10 may include a motherboard (e.g., base printed circuit board) coupling the following: at least one processing unit 11 (computer processor capable of executing computer instruction); form of memory 12 (computer memory for storing executable computer instructions, data, operating system, and computer applications); a wireless Interface 13 (including an wireless interface processor and appropriate antenna); an Internet interface 14 (e.g., a physical interface for a wired connection to Internet resources; a host interface 15 (including a physical interface for connection to a communications port on a host computing device); an internal power source 16, such as a battery for the mobile device 10; and a power connection 17 for externally supplied power to the mobile device 10.

In one embodiment of the present invention, the mobile device 10 and method for isolating a host computing device 50 from internet resources includes a host printed circuit board that can contain circuit traces and mating connectors for connecting other components (11, 12, 13, etc.) of the mobile device 10, or, if the host printed circuit board is the main (motherboard) board, for mounting and connecting the other components. Further, the mobile device 10 includes at least one computer processor (11) for executing instructions that carry out the isolation method, at least one form of non-transitory medium for storing the computer instructions, data, operating system, and applications 12. And further, the mobile device 10 includes a processor and antenna 13 for wirelessly connecting to the host computer 50 and/or to internet resources. The mobile device 10 may include a physical interface 14 for connection to internet resources. Further, the device preferably (but not necessarily) includes of a physical interface for connecting to the host computing device 50 via the host interface 15. Power for the mobile device 10 can be applied through use of this physical interface. Power can also be applied through an internal power source 16 such as a battery or any other on-device power generating source. Power can also be applied through use of an external power connector 17. Preferably (but not necessarily) the mobile device 10 should contain at least two power options. Upon power being applied (15, 16, 17), the processor 11 begins a boot up cycle reading code from the memory 12. Once booted, the mobile device 10 is ready to receive instructions from the host computing device 50. The host computing device 50 makes a secure data connection (preferably but not necessarily) to the mobile device 10 over the physical host interface 15 if it is connected.

The hardware and electrical components of the device and the computer execution instructions stored in memory work together to provide an internet interface that is isolated from the host computing device. The interface between the device and the host computing device may be used to transfer data and commands between the host and the device. The device interprets the host commands and triggers the appropriate applications on the device to handle the host's request and access the internet connection to send and retrieve data of. The processor of the device interfaces with the internet using either the wireless connection or the physical ethernet connection. The wireless connection uses an antenna that preferably (but not necessarily) can communicate on more than one RF frequency band to connect to common WIFI access points, (or Bluetooth, infrared links, etc. The computer instructions (applications) executed on the device provide several applications that handle internet requests from the host. At a minimum, an application to handle host requests for internet access using a web browser is stored in the non-transitory memory of the device. The web browser application can be composed of a proxy server, a web rendering server, and a browser. Together these functions retrieve the requested page, process any active code, and only send Document Object Model (DOM) updates back to the host. Thus, only benign results (i.e. changes in page layout) are transferred and the host browser is protected from receiving any active code from the internet. The web browser application could also implement a Virtual Network Connection (VNC) to the host that would allow the host to view into the browser running on the device 10 and control it. Again, obtaining an isolation of the internet from the host. The device allows for various methods of web browsing isolation to be implemented simultaneously. The device, when constructed with enough storage, can also contain applications in addition to handling web browsing requests from the host such as, file transfer to and from the host, virus scanning of file downloads, host email processing, and many other applications to provide virus and hacking protection for the host computer.

Referring to FIG. 2, a method of utilizing the present invention may include the following. Once power is applied to the mobile systemic device 10/100 and it has completed its boot up process, it searches for a connection to the host computer 110. If there is a physical interface then the mobile systemic device 10/100 will set up a secured/encrypted (preferably but not necessarily) communications protocol with the host computing device 50. If there is no physical interface to the host computing device 50, the device will search for a wireless connection 300 to the mobile systemic device 10/100. Once a wireless connection to the host is found, the mobile systemic device 10/100 will setup a secure/encrypted (preferably but not necessarily) communications protocol with the host 310. Once a secure interface to the host is complete, the mobile systemic device 10/100 will then connect to a global internet resource (210 or 320), begin to monitor global internet traffic using technologies such as Intrusion Detection Systems (IDS), Intrusion Prevention Systems (IPS), and various other methods to monitor, control, and adapt to the global internet data and wait for the host to make an internet request 400 via the local internet connection. When a local internet request is received, the mobile systemic device 10/100 will handle the request by determining if it is a web browser request, email request, or any other type of data request (410, 510, or 610). If a web page request is received then the mobile systemic device 10/100 will access the page over the global internet interface, 420, retrieve the page and let active portions such as JavaScript run on the device 430. The device will send only benign code, DOM updates, and other safe representations of the web page to the host's web browser for viewing and interaction by the user 440. If the request is an email interaction 510, then the device will ensure any embedded links are treated as a web page request, and any attached files are downloaded and scanned 520 by the device before passing them onto the host 530. If the request is any other data request, then any files requested from the internet resource will first be loaded onto the device 620 and scanned before sending them on to the host 630. The device returns to the waiting for a local internet access request 400 state at the end of each transaction.

A method of making the present invention may include the following. The present invention may be made by assembling the various physical and electrical components of the device onto the host board or mother board using common manufacturing processes for printed circuit boards. Once assembled the operating system and web isolation applications may be installed. This is accomplished by flashing or programming the device onboard non-transitory memory with a known good copy of the executable program instructions.

For the present invention to operate it may be minimally required to have at least one local interface to the host device, one computer processor, one non-transitory computer storage, one interface for global internet communication, and one power source. It also may require having computer processor executable instructions sufficient for control of all of the components of the device and to handle at least one internet isolation application such as a web browser isolation and/or IDS.

A method of using the present invention may include the following. A user could apply power to the device. Upon power up completion, the device will become ready for a host computer or device to connect. A person using the host computer or device, having the appropriate software and drivers per its operating system, would connect to the mobile device using a wireless connection or using a communications port on the host computer or device. Once connection between the host and the mobile device is established, the person using the host computer would interact with the internet in the usually manner (web browsing, email, data communications) using standard or custom internet applications that utilize the device as the intermediary between the application and the internet.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of devices configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing cyber security for a host computing device, comprising:
providing a mobile computing device comprising an internet interface configured to isolate the host computing device, wherein the host computing device locally operatively associates with the internet interface, and wherein the internet interface is monitored and configured to intercept, analyze, and transfer electrical data and host requests;
loading a web browser application on the mobile computing device, wherein the software application is configured to handle said host requests for internet access;
retrieving the host requests via the web browser application, wherein the mobile computing device is configured to process active code associated with the host requests; and
sending benign code associated with said host request via the web browser application through the internet interface to the host computing device.

2. The method of claim 1, wherein the web browser application comprises a proxy server and a web rendering server.

3. The method of claim 1, wherein the internet interface is a physical connection.

4. The method of claim 1, wherein the benign code comprises document object model updates.

5. The method of claim 1, wherein the web browser application is configured to implement a virtual network connection to the host computing device, and wherein the virtual network connection enables the host computing device to view and selectively control representations of the active code.

6. The method of claim 1, wherein the web browser application comprises switching functionality configured to determine if said host requests for internet access comprises a web browser request, an email request, or a data request.

7. The method of claim 6, wherein embedded links of the email request are treated as a web browser request, and wherein attached files of the email request are downloaded and scanned by the mobile computing device before sending the email request via the web browser application through the internet interface to the host computing device.

8. A method of providing cyber security for a host computing device, comprising:
providing a mobile computing device comprising an internet interface configured to isolate the host computing device, wherein the host computing device locally and physically operatively associates with the internet interface, and wherein the internet interface is configured to transfer electrical data and host requests;
loading a web browser application on the mobile computing device, wherein the software application is configured to handle said host requests for internet access, wherein the web browser application comprises a proxy server and a web rendering server, wherein the web browser application is configured to implement a virtual network connection to the host computing device, and wherein the virtual network connection enables the host computing device to view and selectively control representations of the active code, wherein the web browser application comprises switching functionality configured to determine if said host requests for internet access comprises a web browser request, an email request, or an data request, and wherein embedded links of the email request are treated as a web browser request, and wherein attached files of the email request are downloaded and scanned by the mobile computing device before sending the email request via the web browser application through the internet interface to the host computing device;
retrieving the host requests via the web browser application, wherein the mobile computing device is configured to monitor and process data received over the global internet interface associated with the host requests; and
sending benign code associated with said host request via the web browser application through the local internet interface to the host computing device.

9. The method of claim 1, wherein the benign code comprises document object model updates.
